(19) United States
(12) Patent Application Publication
(10) Pub. No.: US 2009/0225049 A1
(43) Pub. Date: Sep. 10, 2009

(54) Sliding method for touch control

(75) Inventors: Chung Wei Liu, Jhonghe City (TW); Chen Zhu, Shanghai City (CN)

Correspondence Address: HUDAK, SHUNK & FARINE, CO., L.P.A., 2020 FRONT STREET, SUITE 307, CUYAHOGA FALLS, OH, 44221, US

(73) Assignee: MITAC INTERNATIONAL CORP., Taoyuan (TW)

(21) Appl. No.: 12/378,376

(22) Filed: Feb. 13, 2009

(30) Foreign Application Priority Data
Mar. 5, 2008 (TW) 097107744

(51) Int. Cl. G06F 3/041

(52) U.S. Cl. 345/173

(57) ABSTRACT

The present invention discloses a sliding method for touch control comprising the following steps. First, an input module is used to touch a first position and a second position on a touch display interface, and the touch display interface generates a time signal while being touched. The time signal is compared with a preset time signal to determine stopping actuation or sliding. In case of a sliding motion, first direction actuation is performed when a first direction function is larger than a second direction function, whereas second direction actuation is performed. Next, a velocity function signal is derived according to the distance and the time signal, and then compared with the first and second preset velocity functions to determine first, second or third velocity actuation.

### BACKGROUND OF THE INVENTION

(a) Field of the Invention

The present invention relates to a sliding method, and more particularly to the field of a sliding method applied for a touch display panel.

(b) Description of the Prior Art

Nowadays, touch display panels have been widely applied to mobile equipments, mobile phones, GPS devices, personal digital processing terminals, and the like. Most operation modes of touch panels were click modes in the past, but sliding modes would make the operation of touch panels become more simple and convenient.

Although mobile equipments with touch panels which can be operated by sliding, have been available in the market, there still exist the drawbacks as below:

a. Most of such panels use hardware support, and there is no entire pure software algorithm independent of hardware used.

b. Most sliding sensitivities are not high enough so that it is impossible to determine whether the user's operation is a slide or a click accurately, and this causes high probability of erroneous determination.

c. It is impossible to design the speed of sliding motion entirely depending on the user's sliding velocities.

d. In such electronic device, variations of time, distance and position are calculated according to the duration that a touch stylus touches a touch panel until it moves off the touch panel, and this manner markedly affects the response time of the electronic device.

The above drawbacks results in the significant decreasing of the convenience and compatibility, and further leads to its poor popularity.

In order to resolve all the problems of the prior art, the inventors propose a sliding method for touch control based on their research and development for many years and plenty of practical experience, thereby accomplishing the improvement in the above drawbacks.

### SUMMARY OF THE INVENTION

Therefore, tone of objectives of the present invention is provided a sliding method for touch control, which provides pure software algorithms to achieve sliding for touch control without any special touch IC.

Another objective of the present invention is to provide a sliding method for touch control that can improve the sliding sensitivity and determines whether the user's operation is a slide or a click more accurately.

Another objective of the present invention is to provide a sliding method for touch control that is capable of performing different degrees of sliding in accordance with the user's sliding velocities.

Another objective of the present invention is to provide a sliding method for touch control, which can be performed to provide sliding function on any third party software with a scroll bar, and has excellent compatibility with the software.

Accordingly, to achieve the above objectives, the present invention provides a sliding method for touch control, comprising the following steps. First, an electronic device and an input module are provided, and the electronic device comprises a touch display interface and a data module, and the input module is used to touch the touch display interface to input a first position and a second position away from the first position by a distance on the touch display interface, and the touch display interface generates a time signal while the input module is located thereon.

The time signal is compared with a preset time signal, the actuation is stopped if the time signal is less than the preset time signal, or, actuation is determined to be a sliding motion if the time signal is not less than the preset time signal and the input module is located at the second position, in this case, the first direction actuation is performed when it is determined that the first direction function derived from the distance is larger than the second direction function derived from the distance, and further, the second direction actuation is performed when the second direction function is larger than the first direction function.

Subsequently, a velocity function signal is derived according to the distance and the time signal, and compared with a first and a second preset velocity function. The data module performs a first velocity actuation when the velocity function signal is less than the first preset velocity function, and the data module performs a second velocity actuation when the velocity function signal is larger than the first preset velocity function and less than the second preset velocity function, and the data module performs third velocity actuation when the velocity function signal is larger than the second preset velocity function.

According to the sliding method for touch control provided by the present invention, the processing can be executed exactly and effectively, and its simplification can be fulfilled at the same time.

### BRIEF DESCRIPTION OF THE DRAWINGS

The procedure flowcharts of the preferred embodiments of a sliding method for touch control according to the present invention will be hereinafter described with reference to the related drawings. For the convenience of understanding, the same reference numerals as in the following embodiments denote the same elements.

FIG. 1 is a schematic view showing an input module which touches and slides on a touch display interface.

FIG. 2 is a schematic view of recognizing the sliding direction of an input module which touches and slides on a touch display interface.

FIG. 3 is a flow chart of a first embodiment of a sliding method for touch control according to the present invention.

FIG. 4 is a flow chart of a second embodiment of a sliding method for touch control according to the present invention.

FIG. 5 is a flow chart of a third embodiment of a sliding method for touch control according to the present invention.

### DETAILED DESCRIPTION OF THE PREFERRED EMBODIMENTS

Exemplary embodiments of the present invention are described herein in the context of a sliding method for touch control.

Those of ordinary skilled in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

In accordance with the embodiment(s) of the present invention, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

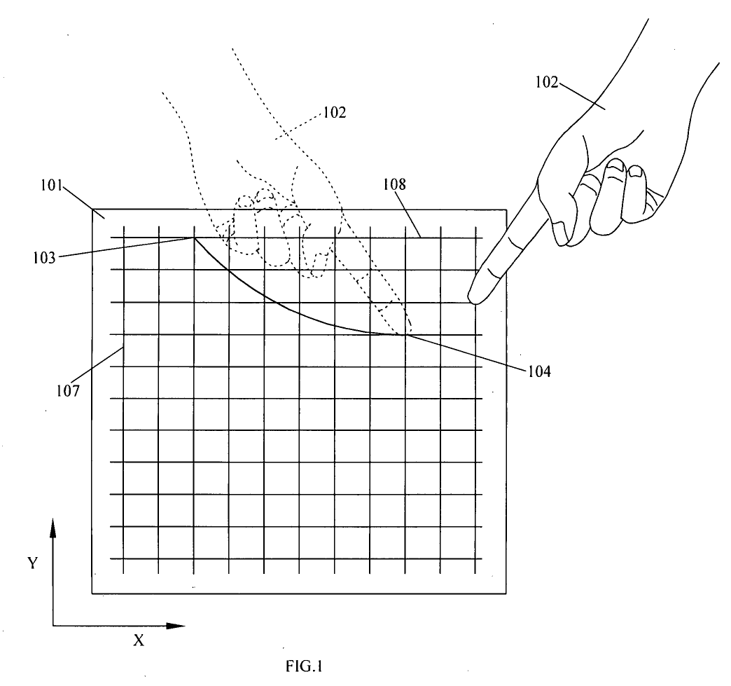

FIG. 1 to FIG. 3 illustrate a schematic view showing an input module which touches and slides on a touch display interface, a schematic view of recognizing the sliding direction of an input module which touches and slides on a touch display interface, and a flow chart of a first embodiment of a sliding method for touch control according to the present invention. The flow chart of this method develops from the start step and comprises the following steps. In step 201, an electronic device and an input module 102 are provided, and the electronic device includes a touch display interface 101 and a data module which has a plurality of data comprising a matrix array of n rows 108 multiplied by m columns 107.

The input module 102 is used to touch at a first position 103 and a second position 104 on the touch display interface 101, and the second position 104 is away from the first position 103 by a distance. Preferably, the electronic device may be a personal computer, a notebook, a personal digital assistant (PDA), a mobile phone, a navigator, and so on. Besides, in this embodiment, a finger, a touch stylus or other similar objects can be used as the input module 102 to touch the touch display interface 101. For the convenience of explanation, the input module 102 used herein is merely representative and is not limited to the disclosure of this embodiment.

In step 202, the electronic device detects the touch of the input module 102 on the touch display interface 101, and at this time, the electronic device starts to count time since the input module 102 touched the touch display interface 101. The electronic device would generate a time signal from the resulting time of touch on the touch display interface 101 counted by a time unit whether the input module 102 moves off the touch display interface 101 or not.

In step 203, the time signal generated in step 202 is compared with a preset time signal to determine whether the time signal is less than the preset time signal or not, and then it is specifically determined through the following steps. The range of the preset time signal can be adjusted according to the requirements of the designer or the user's preferences for the following embodiment.

In step 204, when the time signal detected by the electronic device is less than the preset time signal set by the data module, this indicates that the touch of the input module 102 is a click motion, not a sliding motion. At this time, the electronic device would stop actuation, and step 202 is then proceeded to continue the touch detection. In step 205, when the time signal detected by the electronic device is larger than or equal to the preset time signal and the input module 102 is located at the second position 104 at this time, the touch of the input module 102 is defined as a sliding motion. As shown in FIG. 1, the electronic device detects that the input module 102 slides for a distance ΔS within the time variation ΔT. When the detected time variation ΔT is larger than the preset time signal set by the data module and the first position 103 where the input module 102 starts to touch is away from the second position 104 where the input module 102 finally reaches within the time variation ΔT with a distance, this indicates that such touch of the input module 102 is a sliding motion.

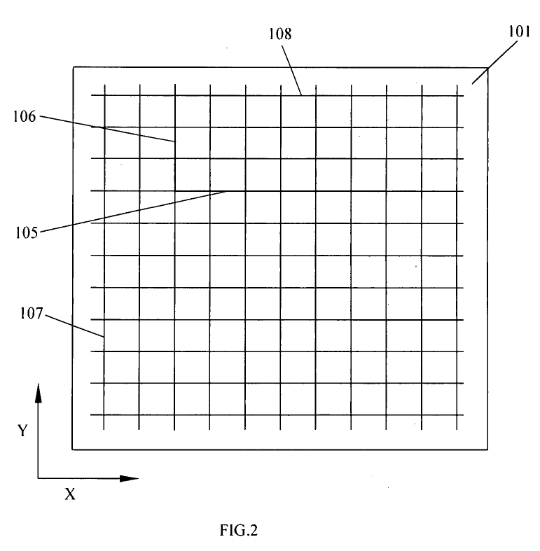

In step 206, a first direction function 105 and a second direction function 106 are derived from the distance between the first position 103 and the second position 104, which is detected by the electronic device, as illustrated in FIG. 2. Preferably, the first direction function 105 and the second direction function 106 can include a distance function, a velocity function and an acceleration function respectively. Furthermore, in this embodiment the X direction is taken as the first direction and the Y direction is taken as the second direction.

In step 207, the actuation performed by the data module is determined according to the first direction function 105 and the second direction function 106. The data module performs first direction actuation when the first direction function 105 exceeds the second direction function 106; the data module performs second direction actuation when the second direction function 106 exceeds the first direction function 105. As illustrated in FIG. 1, when a distance slid by the input module 102 in the X direction is larger than in the Y direction, the data module would perform motion switching according to n rows 108.

In step 208, a distance serving as a divisor, and the time signal serving as a dividend, are used to derive a velocity function signal serving as a quotient. Preferably, the distance serving as the divisor can be optionally determined by the distance between the first position 103 and the second position 104, and can be determined by the distance obtained from the above first direction function 105 or second direction function 106. In this embodiment, the distance obtained from the first direction function 105 is taken as a representation of the distance. The above velocity function signal is directly proportioned to the distance obtained from the first direction function 105, and the velocity function signal is inversely proportioned to the time signal.

In step 209, the velocity function signal obtained from the above step is compared with a first preset velocity function and a second preset velocity function respectively, and in step 210 actuation velocity of the data module actuates is determined according to the comparison result. When the velocity function signal does not reach the first preset velocity function set by the data module, the data module would perform first velocity actuation which is the slowest sliding velocity; When the velocity function signal exceeds the first preset velocity function set by the data module but does not reach the second preset velocity function set by the data module, the data module would perform second velocity actuation which is moderate sliding velocity; When the velocity function signal exceeds the second preset velocity function set by the data module, the data module would perform third velocity actuation which is the fastest sliding velocity.

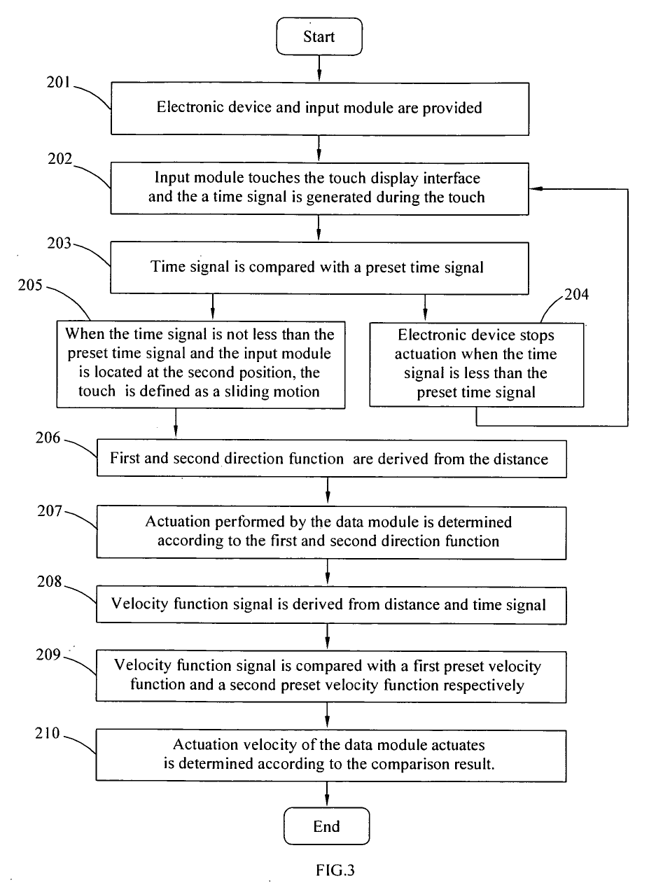

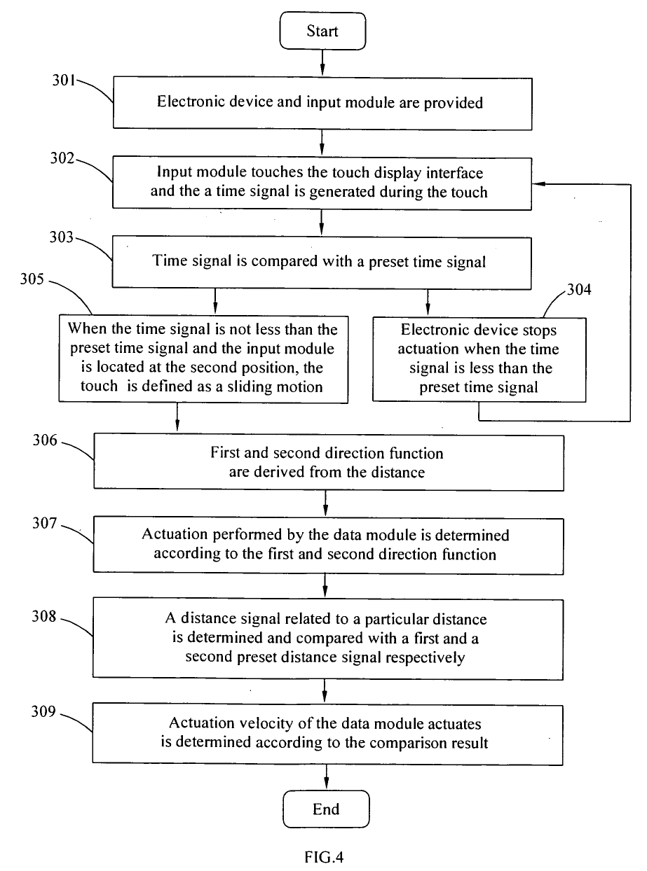

FIG. 1, FIG. 2 and FIG. 4 illustrate a schematic view showing an input module which touches and slides on a touch display interface, a schematic view of recognizing the sliding direction of an input module which touches and slides on a touch display interface, and a flow chart of a second embodiment of a sliding method for touch control according to of the present invention. In this embodiment, steps 301 to 305 of this method are the same as steps 201 to 205 of the method as mentioned above in FIG. 3 and therefore will be described in detail no more. The difference between the second embodiment and the first embodiment is from step 306.

In step 306, a first direction function 105 (indicating the number of rows to be slid here) and a second direction function 106 (indicating the number of columns to be slid here) are derived from the distance between the first position 103 and the second position 104 detected by the electronic device, as illustrated in FIG. 2. Also, the X direction is taken as the first direction and the Y direction is taken as the second direction.

In step 307, actuation performed by the data module is determined according to the first direction function 105 and the second direction function 106. The data module performs first direction actuation when the first direction function 105 exceeds the second direction function 106; the data module performs second direction actuation when the first direction function 105 exceeds the second direction function 106. As illustrated in FIG. 1, when a distance slid by the input module 102 in the X direction is larger than in the Y direction, the data module would perform motion switching according to n rows 108.

In step 308, a distance signal related to a particular distance is determined and compared with a first preset distance signal and a second preset distance signal respectively. This particular distance is optionally determined by the distance between the first position 103 and the second position 104, and can be determined by the distance obtained from the first direction function 105 (the number of rows to be slid) and second direction function 106 (the number of columns to be slid). In this preferred embodiment, the number of rows to be slid obtained from the first direction function 105 is taken as a representation of this particular distance.

The number of rows to be slid obtained from the first direction function 105 within a fixed time interval Δt, such as 1 sec, represents this particular distance, so that velocity V equals to the number of rows slid within 1 s from the velocity function equation V=ΔS/Δt, so that V can be the distance slid within the fixed time interval. It can be derived from the acceleration function equation: a=ΔV/Δt that “a” is directly proportioned to velocity variation ΔV. Thus, based on the fixed time interval of 1 second, the magnitude of acceleration “a” can also be determined from the distance slid within the fixed time interval.

In step 309, actuation velocity of the data module actuates is determined according to the comparison result obtained in step 308. When the distance signal does not reach the first preset distance signal set by the data module, the data module would perform first velocity actuation which is the slowest the sliding velocity; when the distance signal exceeds the first preset distance signal set by the data module but does not reach the second preset distance signal set by the data module, the data module would perform second velocity actuation which is moderate sliding velocity; when the distance signal exceeds the second preset distance signal set by the data module, the data module would perform third velocity actuation which is the fastest sliding velocity.

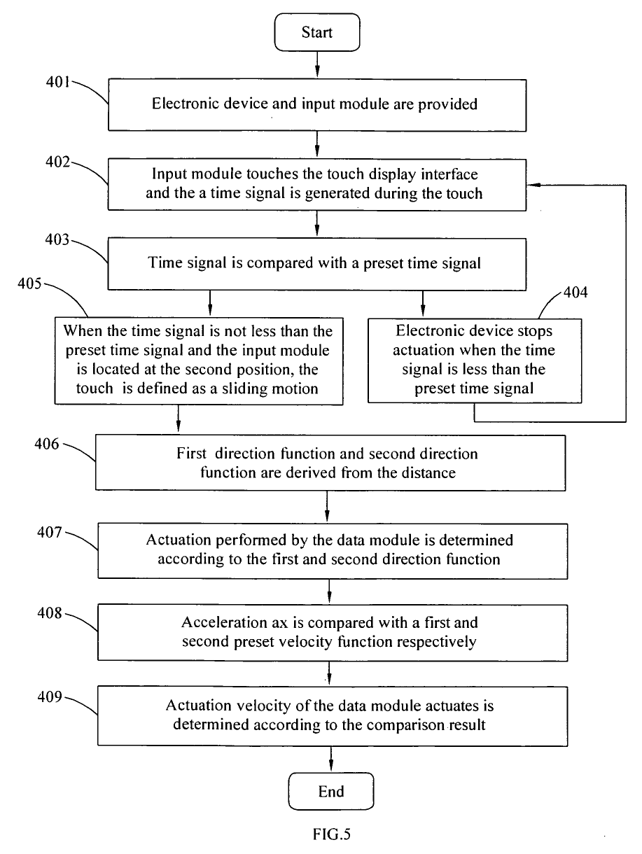

FIG. 1, FIG. 2 and FIG. 5 illustrate a schematic view showing an input module which touches and slides on a touch display interface, a schematic view of recognizing the sliding direction of an input module which touches and slides on a touch display interface, and a flow chart of a third embodiment of a sliding method for touch control according to the present invention. In the drawings, steps 401 to 405 of the third embodiment are the same as steps 201 to 205 of the other embodiments as mentioned above for FIG. 3 and therefore will be described in detail no more. The difference between the third embodiment and the other embodiments is from step 406.

In step 406, a first direction function 105 indicating the acceleration ax in the X direction in this embodiment, and a second direction function 106 indicating the acceleration ay in the Y direction in this embodiment, are derived from the distance between the first position 103 and the second position 104 detected by the electronic device, as illustrated in FIG. 2. Also, the X direction is taken as the first direction and the Y direction is taken as the second direction.

The acceleration ax in the X direction obtained from the first direction function 105 and the acceleration ay in the Y direction obtained from the second direction function 106 mentioned above are calculated in accordance with the velocity function equation ΔS=½×a×t² for the accelerations in the X and Y directions. If the absolute value of ax is larger than that of ay, it indicates that the touch of the input module is a leftward or rightward slide, and such slide moving left or right depends on the plus or minus sign of ax; if the absolute value of ax is less than that of ay, it indicates that the touch of the input module is an upward or downward slide, and such slide moving up or down depends on the plus or minus sign of ay.

In step 407, the actuation performed by the data module is determined by the first direction function 105 and the second direction function 106. In this embodiment, the first direction function 105 indicates the acceleration ax in the X direction and the second direction function 106 indicates the acceleration ay in the Y direction. The data module performs first direction actuation when the first direction function 105 exceeds the second direction function 106; the data module performs second direction actuation when the first direction function 105 exceeds the second direction function 106. As illustrated in FIG. 1, when a distance slid by the input module 102 in the X direction is larger than in the Y direction, the data module would perform motion switching according to n rows 108.

In step 408, the velocity function signals include the acceleration ax in the X direction obtained from the first direction function 105 in the above step. Therefore, in this preferred embodiment, acceleration ax is taken as a representation of the velocity function, and acceleration ax is compared with a first preset velocity function and a second preset velocity function respectively, and the actuation velocity of the data module is determined according to the comparison result in step 409.

When the velocity function signal does not reach the first preset velocity function set by the data module, the data module would perform first velocity actuation which is the slowest sliding velocity; when the velocity function signal exceeds the first preset velocity function set by the data module but does not reach the second preset velocity function set by the data module, the data module would perform second velocity actuation which is a moderate sliding velocity; when the velocity function signal exceeds the second preset velocity function set by the data module, the data module would perform third velocity actuation which is the fastest sliding velocity.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiment(s) of the present invention.

What is claimed is:

1. A sliding method for touch control comprising the steps of:
(A) providing an electronic device and an input module, wherein the electronic device includes a touch display interface and a data module, and the input module is used to touch at a first position and a second position with a distance away from the first position on the touch display interface;
(B) locating the input module on the touch display interface to generate a time signal;
(C) comparing the time signal with a preset time signal;
(D) stopping actuation when the time signal is less than a preset time signal; and
(E) using the distance and the time signal to derive a velocity function signal when the time signal is not less than the preset time signal and the input module is located at the second position, and comparing the velocity function signal with a preset velocity function to determine a sliding velocity.

2. The sliding method for touch control as claimed in claim 1 further comprising, after step (D), the steps of:
(D1) deriving a first direction function and a second direction function from the distance; and
(D2) controlling the data module to perform a first direction actuation when the first direction function is larger than the second direction function, and controlling the data module to perform a second direction actuation when the first direction function is larger than the second direction function.

3. The sliding method for touch control as claimed in claim 1 further comprising, after step (E), the steps of:
(E1) comparing the velocity function signal with a first preset velocity function and a second preset velocity function respectively; and
(E2) controlling the data module to perform a first velocity actuation when the velocity function signal is less than the first preset velocity function; controlling the data module to perform a second velocity actuation when the velocity function signal is larger than the first preset velocity function and less than the second preset velocity function; and controlling the data module to perform a third velocity actuation when the velocity function signal is larger than the second preset velocity function.

4. A sliding method for touch control comprising the steps of:
(A) providing an electronic device and an input module, wherein the electronic device includes a touch display interface and a data module, and the input module is used to touch a first position and a second position with a distance away from the first position on the touch display interface;
(B) locating the input module on the touch display interface to generate a time signal;
(C) comparing the time signal with a preset time signal;
(D) stopping actuation when the time signal is less than the preset time signal; and
(E) deriving a first direction function and a second direction function from the distance when the time signal is not less than the preset time signal and the input module is located at the second position; and
(F) controlling the data module to perform a first direction actuation when the first direction function is larger than the second direction function; controlling the data module to perform a second direction actuation when the first direction function is larger than the second direction function.

5. The sliding method for touch control as claimed in claim 4 further comprising, after step (F), the steps of:
(G) deriving a velocity function signal according to the distance and the time signal;
(H) comparing the velocity function signal with a first preset velocity function and a second preset velocity function respectively; and
(I) controlling the data module to perform a first velocity actuation when the velocity function signal is less than the first preset velocity function; controlling the data module to perform a second velocity actuation when the velocity function signal is larger than the first preset velocity function and less than the second preset velocity function; controlling the data module to perform a third velocity actuation when the velocity function signal is larger than the second preset velocity function.

6. A sliding method for touch control comprising the steps of:
(A) providing an electronic device and an input module, wherein the electronic device includes a touch display interface and a data module, and the input module is used to touch a first position and a second position with a distance away from the first position on the touch display interface;
(B) locating the input module on the touch display interface to generate a time signal;
(C) comparing the time signal with a preset time signal;
(D) stopping actuation when the time signal is less than the preset time signal;
(E) deriving a distance signal from the distance when the time signal is not less than the preset time signal and the input module is located at the second position, and comparing the distance signal with a preset distance signal to determine a sliding velocity.

7. The sliding method for touch control as claimed in claim 6 further comprising, after step (D), the steps of:
(D1) deriving a first direction function and a second direction function from the distance; and
(D2) controlling the data module to perform first direction actuation when the first direction function is larger than the second direction function; controlling the data module to perform second direction actuation when the first direction function is larger than the second direction function.

8. The sliding method for touch control as claimed in claim 6 further comprising, after step (E), the steps of:
(E1) comparing the distance signal with a first preset distance signal and a second preset distance signal respectively; and
(E2) controlling the data module to perform a first velocity actuation when the distance signal is less than the first preset distance signal; controlling the data module to perform a second velocity actuation when the distance signal is larger than the first preset distance signal and less than the second preset distance signal; controlling the data module to perform a third velocity actuation when the distance signal is larger than the second preset distance signal.
